(19) United States
(12) Patent Application Publication
(10) Pub. No.: US 2008/0193250 A1
(43) Pub. Date: Aug. 14, 2008

(54) Fixing Rivet

(75) Inventor: Mohieddine Boubtane, Seyssinet-Pariset (FR)

Correspondence Address: BAKER & DANIELS LLP;111 E. WAYNE STREET, SUITE 800, FORT WAYNE, IN, 46802, US

(73) Assignee: A. RAYMOND ET CIE, Grenoble (FR)

(21) Appl. No.: 11/816,019

(22) PCT Filed: Jan. 5, 2006
(86) PCT No.: PCT/EP2006/000050

§ 371 Date: Oct. 18, 2007

(30) Foreign Application Priority Data
Feb. 17, 2005 (FR) 0501702

(51) Int. Cl. F16B 19/10; F16B 13/02; F16B 21/07

(52) U.S. Cl. 411/48

(57) ABSTRACT

A detachable metal fixing rivet comprising a retaining body (12) and a pin (11) having an elongate shaft equipped with at least a first notch and a second notch spaced longitudinally along the shaft (14). The retaining body (12) is made of cut and folded metal sheet, having a first pair of guide tabs (24a) for guiding the shaft (14), and a second pair of elastic tabs (25a) provided with a series of latching lugs (40) that ensure positive locking at the end of the insertion travel of the pin (11) into the body (12). The first pair of guide tabs (24a) is provided with at least one spring leaf (27a) cooperating either with the first notch (16a) of the shaft (14), in an “up,” premounted position of the pin (11), or with the second notch, in a “down,” locking position.

### BACKGROUND OF THE INVENTION

1. Field of the Invention

The present invention relates to a fixing rivet comprising a retaining body equipped with latching means, and an actuating pin designed to move the latching means toward an active, locking position.

A fixing rivet of this kind permits the rapid assembly of one or more elements, particularly in the form of panels or plates, each being provided with a hole.

2. Description of the Related Art.

The documents FR 2852639 and EP 1473449 describe a plastic rivet comprising a central pin that can be driven in to lock the assembly. Dismounting is effected by pulling on or turning the pin, thus raising it so the rivet can be extracted. Dismounting can be problematic in cases where the rivet is installed in a circular hole and where the rotating action is exerted, not on the pin, but on the rivet as a whole. The latter then turns on itself, making it impossible to dismount.

In cases where such a plastic rivet is installed in a high-stress environment, for example to secure a protective shield under an automotive-vehicle engine, the presence of a plastic locking pin does not guarantee adequate mechanical strength, resulting over time in premature wear and the risk of breakage.

Metal rivets also exist that are put in place by means of a special pliers that produce a retaining bead, formed by crimping, on the back of the support. The bead is obtained by irreversibly deforming the material, making it impossible to dismount the rivet for reuse. To extract the rivet, it is necessary to destroy the head with a power drill. The rivet then has to be thrown away after being dismounted.

### SUMMARY OF THE INVENTION

The object of the invention is to devise a rivet that can easily be mounted and dismounted without tools, and that has the advantage of high mechanical strength regardless of the thickness of the element to be fixed and the thickness of the support.

The rivet according to the invention is characterized in that

the pin has an elongate shaft equipped with at least a first notch and a second notch spaced longitudinally along the shaft,
the retaining body is made from a cut and folded metal sheet having a first pair of guide tabs (14) for guiding the shaft, and a second pair of elastic tabs provided with a series of latching lugs that ensure positive locking at the end of the insertion travel of the pin into the body.

According to a preferential embodiment of the invention, the first pair of guide tabs is provided with at least one spring leaf cooperating either with the first notch of the shaft, in an “up,” premounted position of the pin, or with the second notch, in a “down,” locking position. The latching tabs of the second pair are longer than the guide tabs of the first pair, and have ends that are bent back toward each other to form a V-shaped actuating region that causes said latching tabs to spread apart as the pin is driven in.

The metal rivet according to the invention makes it possible to obtain good mechanical strength and high pullout resistance when the pin is in the down, locking position. The mounting of the rivet is performed without tools, and the thickness of the support and the element to be fixed can vary. The dismounting and extraction of the metal rivet are performed after the unlocking and raising of the pin.

### BRIEF DESCRIPTION OF THE DRAWINGS

The above mentioned and other features and objects of this invention, and the manner of attaining them, will become more apparent and the invention itself will be better understood by reference to the following description of embodiments of the invention taken in conjunction with the accompanying drawings, wherein:

FIG. 1 is a schematic perspective view of the rivet according to the invention, the pin being shown inserted in the body in an up, premounted position;

FIGS. 2A and 2B are perspective elevational views of the pin of FIG. 1;

FIG. 3A shows a perspective view of the body of FIG. 1 after removal of the pin;

FIGS. 3B, 3C and 3D are, respectively, a profile view, a front view, and a view of a not-yet-folded cut metal sheet for the body of FIG. 3A;

FIGS. 4A and 4B are elevational and perspective views of the insert of FIG. 1;

FIG. 5 shows an exploded perspective view of an assembly with the rivet of FIG. 1;

FIG. 6 shows the assembly of FIG. 5 after the rivet has been put in place; and

FIGS. 7 and 8 are sectional views of FIG. 6, with the pin respectively in the up, premounted position and in the down, locking position.

Corresponding reference characters indicate corresponding parts throughout the several views. Although the exemplifications set out herein illustrate embodiments of the invention, in several forms, the embodiments disclosed below are not intended to be exhaustive or to be construed as limiting the scope of the invention to the precise forms disclosed.

### DETAILED DESCRIPTION

Referring to the figures, a metal fixing rivet 10 is composed of an actuating pin 11 and a retaining body 12 into which the pin 11 is inserted in order to assemble one or more elements.

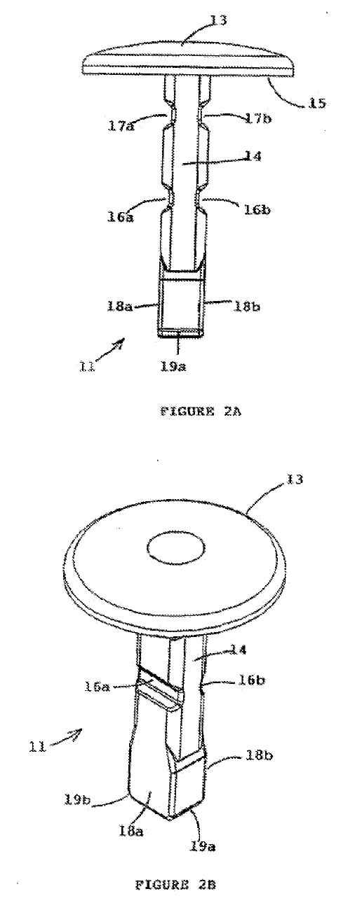

The pin 11 (FIGS. 2A and 2B) comprises a broad head 13 of circular section, joined to an elongate vertical shaft 14. The annular bottom face 15 of the head 13 serves as an actuating surface for raising the pin 11 by means of a tool during dismounting. The shaft 14 has a substantially quadrangular section and is provided with first notches 16a, 16b and second notches 17a, 17b spaced along two opposite, parallel faces and serving respectively to hold the pin 11 in an up position and to lock it in a down position. The second notches 17a, 17b are located farther up, immediately beneath the head 13, while the first notches 16a, 16b are farther down, between second notches 17a, 17b and the end portion. Each of the four notches 16a, 16b, 17a, 17b has the same chamfered, V-shaped profile, to reduce frictional loads during the placement or dismounting of the pin 11. The end portion is provided with two support regions 18a, 18b provided beneath the first notches 16a, 16b and designed to cooperate with the body 12. On the other two opposite faces of the shaft 14, the edges 19a, 19b of the end portion are beveled.

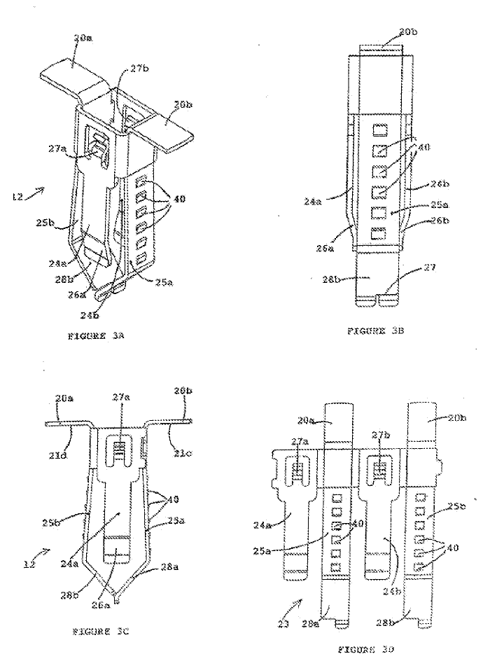

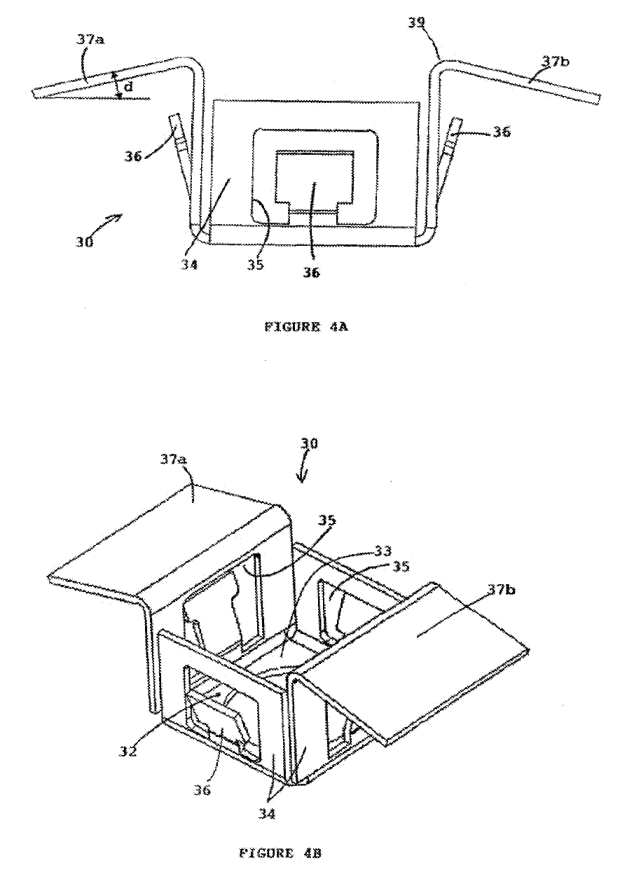

In FIGS. 3A to 3D, the retaining body 12 of the rivet 10 is made from a cut and folded metal sheet 23, and comprises, in the upper portion, two bent-down lateral winglets 20a, 20b serving to brace the body 12 against the top surface 21 of the element 22 to be fixed. The body 12 further comprises a first pair of elastic guide tabs 24a, 24b for guiding the pin 11, and a second pair of elastic tabs 25a, 25b, each provided with a series of latching lugs 40 that ensure positive locking when the pin 11 is inserted.

The guide tabs 24a, 24b of the first pair are provided at their bottom ends with two pressure tongues 26a, 26b that are urged elastically against the flanks of the shaft 14 to hold the pin 11 in place in the longitudinal insertion direction. Two other spring leaves 27a, 27b protrude from the upper portion toward the inside of guide tabs 24a, 24b, and cooperate with notches 16a, 16b, 17a, 17b to lock the pin 11 in different positions.

The tabs 25a, 25b of the second pair are longer than the guide tabs 24a, 24b of the first pair, and the ends 28a, 28b are bent back toward each other to form a V-shaped actuating region that causes the tabs 25a, 25b to spread apart as the pin 11 is driven in.

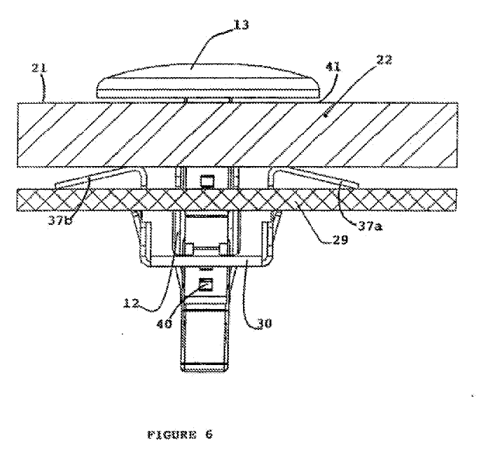

The rivet 10 serves to dismountably fix the element 22 on a support 29. The support 29 can be a rigid material, for example a metallic material; or a flexible material, made for example of plastic. A metal insert 30 is used to ensure mechanical strength in the case of a flexible support 29, since the lugs 40 of the rivet 10 will then be latched to a rigid material. An insert 30 may also be used with a rigid support 29. As examples, the element 22 to be fixed and the support 29 are illustrated in the form of plates or panels in FIGS. 5 to 8.

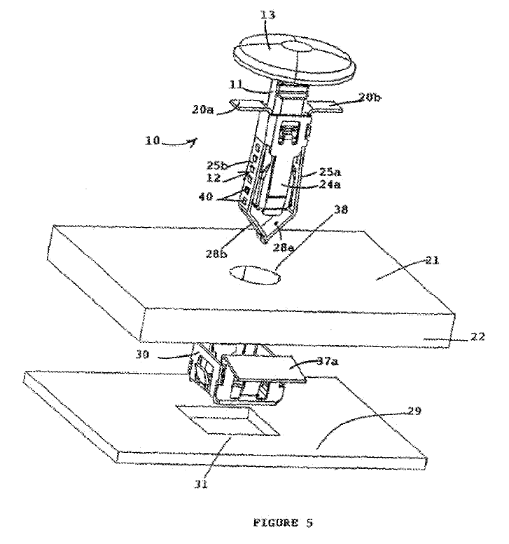

According to FIGS. 4A and 4B, the insert 30 made of cut and folded sheet metal has a substantially square shape designed to be inserted into a complementarily shaped hole 31 in support 29. Insert 30 has a bottom 32 pierced by a circular orifice 33, and four rectangular lateral faces 34 set at a right angle to form a parallelepipedally shaped receptacle. Each lateral face 34 is perforated by a rectangular opening 35, within which extends a flexible fixing tab 36 that is bent slightly outward to hold and lock insert 30 in hole 31 of support 29. Two opposite lateral faces 34 are prolonged by two elastic wings 37a, 37b that are bent outward in opposite directions, each forming an acute angle d with the horizontal direction. After insert 30 has been placed in hole 31, the presence of the two elastic wings 37a, 37b makes it possible to accommodate different thicknesses of element 21, owing to the elasticity of the deflecting region 39.

The orifice 33 in the bottom 32 of insert 30 is advantageously circular to eliminate any problems positioning the insert relative to the pin 11 and vice versa. The external lugs 40 on the body 12 latch onto the back of the orifice 33 of insert 30 as a result of the driving-in of the pin 11 causing the second pair of tabs 25a, 25b to spread apart.

The through-hole 38 for inserting the rivet 10 in the element 22 to be fixed has, for example, a circular section, but other shapes are possible as long as the wings 20a, 20b of the body 12 can bear against the top surface 21 of element 22.

The mounting of the rivet 10 for the assembly of element 22 to support 29 takes place in the following manner:

Use of the insert 30 is possible regardless of the material of the support 29, whether it be metallic or of deformable plastic. The insert 30 makes it possible to adapt to the support 29, the hole 31 of which is not always designed for optimum attachment of the rivet.

Absence of Insert 30

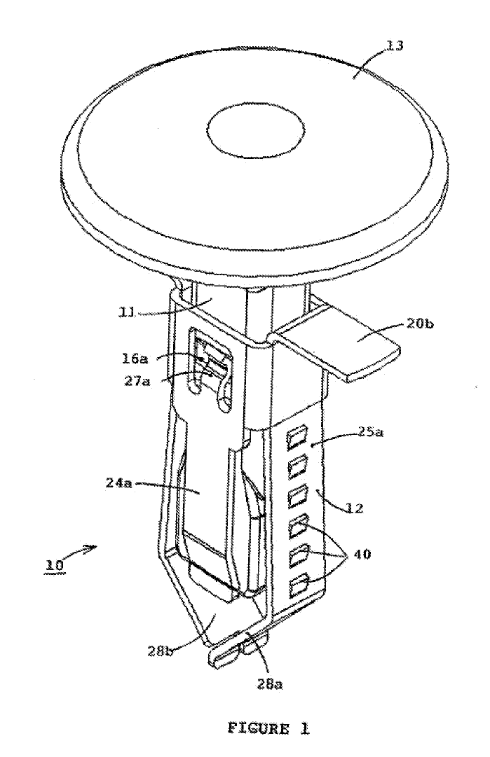

In the case of a rigid support 29 with no insert 30, the rivet 10 is used directly with the pin 11 premounted in the retaining body 12 (FIG. 1). The pin 11 is disposed held in the “up,” premounted position after the engagement of the spring leaves 27a, 27b of the first pair of guide tabs 24a, 24b in the first notches 16a, 16b of shaft 14.

The shape of the hole 31 in support 29 must be dimensioned to receive the second pair of latching tabs 25a, 25b of the body 12. The ideal shape is a circular hole 31, to eliminate any problems positioning the body 12 relative to the pin 11.

The V-shaped ends 28a, 28b of the latching tabs 25a, 25b of body 12 facilitate the introduction of the rivet 10 into the through-hole 38 of element 22 and into the hole 31 of support 29. The rivet 10 is driven in until the winglets 20a, 20b of body 12 come to bear against the top surface 21 of the element 22 to be fixed.

Pushing on the pin 11 in the driving-in direction then causes the release of spring leaves 27a, 27b from first notches 16a, 16b of shaft 14, followed, after some travel, by their insertion into second notches 17a, 17b. The pin 11 is then in the down, locking position due to the spreading apart of the latching tabs 25a, 25b of body 12, causing the lugs 40 to become implanted in the support 29.

Presence of Insert 30

In this case, the hole 31 in the support 29 has a square shape that is slightly larger than the outer dimensions of the insert 30. Once the insert 30 has been snapped into the hole 31, the anchoring of the four fixing tabs 36 permits captive mounting on the support 29. The presence of the two flexible wings 37a, 37b further allows the support 29 to be of different thicknesses.

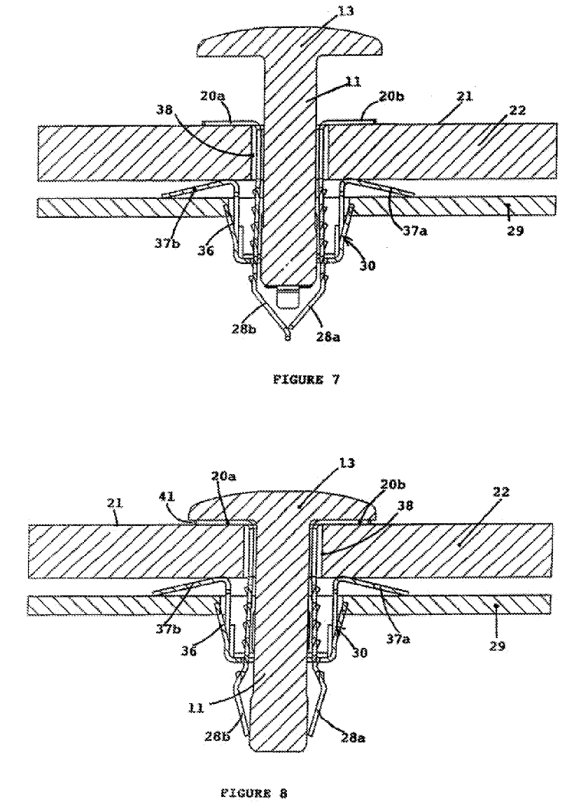

The operations of driving in and locking the rivet 10 are illustrated in FIGS. 7 and 8, and take place in the same manner as in the “no insert” solution described above. The only difference has to do with the lugs 40 of the latching tabs 25a, 25b, which catch beneath the circular orifice 33 of the insert 30, instead of gripping onto the bottom surface of the support 29 in the down, locking position of the pin 11.

The element 22 to be fixed can have different thicknesses, the difference being made up by means of the lugs 40 spacedly distributed over the latching tabs 25a, 25b in the heightwise direction.

Dismounting the Rivet 10

In FIGS. 6 and 8, illustrating the down, locking position of the pin 11, a clearance 41 is provided between the head 13 of the pin 11 and the top surface 21 of the element 22 to be fixed. The thickness of the clearance 41 is substantially the same as the thickness of the winglets 20a, 20b of the body 12. All that is necessary is to insert the blade of a screwdriver in this clearance 41, displacing the pin 11 upward, for the spring leaves 27a, 27b to be dislodged from the first notches 16a, 16b on the shaft 14. Traction is exerted on the pin 11 until the spring leaves 27a, 27b engage in second notches 17a, 17b, corresponding to the up position (FIGS. 7 and 5).

Continuing with the extraction movement then allows the rivet 10 to be withdrawn completely, since the force required to disengage the spring leaves 27a, 27b from the second notches 17a, 17b is greater than the force required to extract the entire rivet 10 when the pin 11 is in the up, unlocked, premounted position.

The advantages of the metal rivet 10 according to the invention are as follows:

good mechanical strength and high pullout resistance when the pin 11 is in the down, locking position;
ease of mounting the rivet without tools;
more than one thickness possible for the support 29 and the element 22 to be fixed;
dismounting and extraction of the metal rivet 10 after unlocking of the pin 11;
ability of the rivet to be reused a number of times.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1-9. (canceled)

10. A fixing rivet comprising:
a retaining body (12) with a latching means and an actuating pin (11), said actuating pin adapted to move said latching means toward an active, locking position;
said pin (11) having an elongate shaft (14) equipped with a first notch (16a, 16b) and a second notch (17a, 17b), said first and second notches spaced longitudinally along said shaft (14); and
said retaining body (12) made from a cut and folded metal sheet, said retaining body having a first pair of guide tabs (24a, 24b) for guiding said shaft (14), and a second pair of elastic tabs (25a, 25b), said second pair of tabs provided with a series of latching lugs (40) for ensuring positive locking at the end of the insertion travel of said pin (11) into said body (12).

11. The fixing rivet of claim 10, wherein said first pair of guide tabs (24a, 24b) is provided with at least one spring leaf (27a, 27b) which are adapted to cooperate with one of said first notch (16a, 16b) of said shaft (14), in an up, premounted position of said pin (11), and with said second notch (17a, 17b), in a down, locking position.

12. The fixing rivet of claim 10, wherein said second pair of latching tabs (25a, 25b) are longer than said first pair of guide tabs (24a, 24b), and have ends (28a, 28b) that are bent back toward each other to form a V-shaped actuating region that causes said latching tabs to spread apart as said pin (11) is driven in.

13. The fixing rivet of claim 10, wherein said body (12) is provided with two lateral winglets (20a, 20b) configured in the upper portion of said second pair of tabs (25a, 25b).

14. The fixing rivet of claim 10, wherein said lugs (40) are distributed longitudinally in the intermediate portion of each said second pair of tabs (25a, 25b).

15. The fixing rivet of claim 11, wherein each of said first pair of guide tabs (24a, 24b) is provided, opposite said spring leaf (27a, 27b), with a pressure tongue (26a, 26b) that is urged elastically against said shaft (14) to hold said pin (11) in place in the longitudinal insertion direction.

16. The fixing rivet of claim 10, wherein said pin (11) has a head (13) that is larger in section than said shaft (14).

17. The fixing rivet of claim 16, wherein said shaft (14) is quadrangular in section.

18. The fixing rivet of claim 10, wherein the locking of said second pair of tabs (25a, 25b) takes place at the back of a circular orifice (33) provided in the bottom (32) of a metallic insert (30).
